(19) United States
(12) Patent Application Publication
(10) Pub. No.: US 2017/0312767 A1
(43) Pub. Date: Nov. 2, 2017

(54) WATER DISTRIBUTION DEVICE FOR FAMILY SHOWERING

(71) Applicant: Raymond Hassanlou, Sherman Oaks, CA (US)

(72) Inventor: Raymond Hassanlou, Sherman Oaks, CA (US)

(21) Appl. No.: 15/653,410

(22) Filed: Jul. 18, 2017

Related U.S. Application Data
(63) Continuation-in-part of application No. 14/276,899, filed on May 13, 2014.
(60) Provisional application No. 62/424,339, filed on Nov. 18, 2016.

(51) Int. Cl. B05B 1/14; B05B 15/06

(52) U.S. Cl. CPC B05B 1/14; B05B 15/065

(57) ABSTRACT

A light weight, inexpensive water distribution device for family showering includes a hollow chamber for collecting and distributing water. The chamber includes an inlet port and a plurality of outlet ports for providing outflow for the received water. An inlet pipe can be attached to the inlet port capable of connection to a water supply pipe whence the water distribution device is suspended from the water supply pipe without additional support. A plurality of linear pipes is provided, each one of the linear pipes connected to a respective one of the outlet ports; wherein distal ends of each of the long straight pipes are structured to permit a respective shower head to be attached. In an embodiment, the linear pipes are between about six inches and ten inches in length and are pointed at an angle toward a side rather than directly downward to facilitate convenient family showering for all participants. Pairs of the linear pipes can be arranged in either a crossing or parallel configuration.

### CROSS-REFERENCE TO RELATED APPLICATIONS

This application is a continuation-in-part of pending application Ser. No. 14/276,899, filed on May 13, 2014, entitled “MULTI-FACETED SHOWER HEAD MECHANISM” and claims the benefit of provisional application Ser. No. 62/424,339, filed Nov. 18, 2016, the subject matter of both applications which are incorporated herein by reference.

### BACKGROUND OF THE INVENTION

### 1. Field of the Invention

The present invention relates to a light weight, inexpensive water distribution device for family showering.

### 2. Description of the Related Art

Showering is an activity that millions of people make a part of their daily routine. It is a fast, effective and refreshing way to get clean. A shower (or shower-bath, walk-in shower, steam shower) is a place in which a person bathes under a spray of water, typically warm or hot water. The water is drained through a drain in the shower base. Modern showers come with configurable temperature and spray pressure settings, along with adjustable shower head nozzle settings.

Although most people choose to shower alone, some prefer to shower together at times. For example, couples may enjoy showering together and young children may find it fun to shower together. However, because traditional showerheads are designed for single person usage, they are extremely limited in their range and therefore do not allow more than one person to conveniently shower at the same time.

Accordingly, there is a need for a light weight water distribution device that can be used in an existing shower to accommodate a group of people showering at the same time without the problems of conventional mechanisms.

### SUMMARY OF THE INVENTION

A water distribution device for family showering is constructed of lightweight materials allowing it to be used in place of an existing showerhead. The device is less than about three pounds, most preferably less than one pound, in weight. The device is easily installed and can be suspended from a water source pipe in a shower without undue strain. The water distribution device for family showering includes a hollow chamber. The hollow chamber includes an inlet port and a plurality of outlet ports for providing outflow for the received water. An inlet pipe can be attached to the inlet port capable of connection to a water supply pipe wherein, the water distribution device is suspended from the water supply pipe without additional support. A plurality of linear pipes is provided, each one of the linear pipes connected to a respective one of the outlet ports; wherein distal ends of each of the long straight pipes are structured to permit a respective standard-size shower head to be attached. In an embodiment, the linear pipes are between about four inches and ten inches in length. In an embodiment, the linear pipes are pointed at an angle toward a side rather than directly downward to facilitate convenient family showering for all participants. Pairs of the linear pipes can be arranged in either a crossing or parallel configuration.

### BRIEF DESCRIPTION OF THE DRAWINGS

FIG. 1 shows a perspective view of a water distribution device for family showering according to an embodiment of the present invention.

FIG. 2 shows a top view of the water distribution device for family showering of FIG. 1.

FIG. 3 shows a perspective view of a water distribution device for family showering according to another embodiment of the present invention

FIG. 4 shows a perspective view of a water distribution device for family showering according to yet another embodiment of the present invention.

FIG. 5 shows a top view of the water distribution device for family showering of FIG. 4.

FIG. 6 shows a perspective view of a water distribution device for family showering according to yet another embodiment of the present invention.

### DETAILED DESCRIPTION OF THE INVENTION

Details of the various embodiments of the present invention will now be discussed by reference to the drawings.

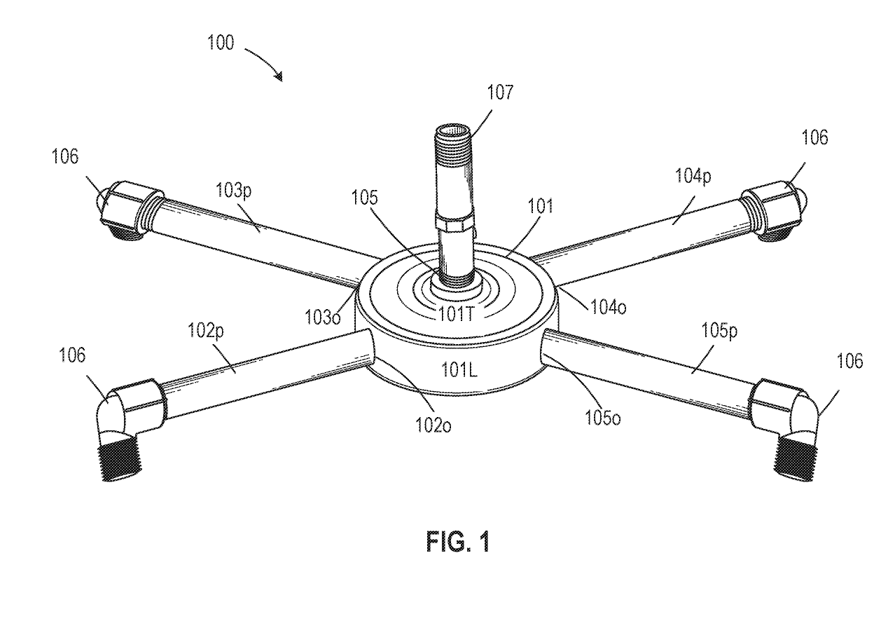

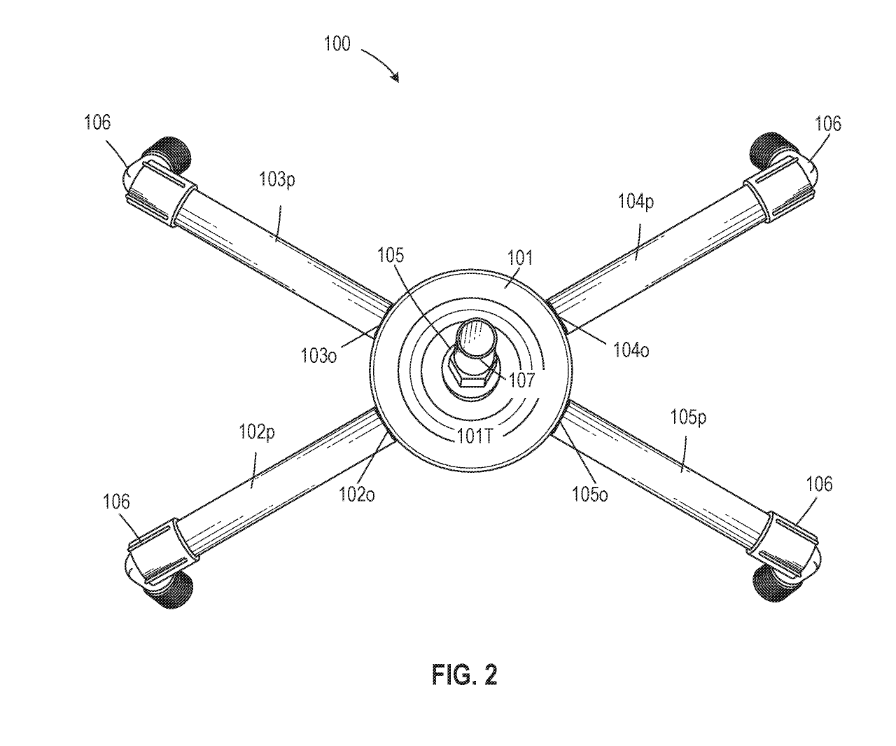

Referring to FIG. 1, a perspective view of a water distribution device for family showering 100, according to an embodiment of the present invention, is illustrated. FIG. 2 shows a top view of the water distribution device for family showering 100. As shown, the water distribution device for family showering 100 includes a chamber 101 that has an inlet port 105 disposed on a top side 101T and a plurality of outlet ports 102o-105o disposed on a lateral side 101L thereof. Each of the outlet ports 102o-105o connects with a respective linear pipe 102p-105p, as shown. Although the chamber 101 is shown as a cylinder, it is to be understood that the chamber 101 could assume another suitable shape, e.g., a dome, a cube. The chamber 101 has a hollow interior that collects pressurized water entering through the inlet port 105 and expels the water through the outlet ports 102o-105o. The expelled water flows through each of the linear pipes 102p-105p, and exits from respective distal ends that can be fitted with elbow pipes 106, as shown. To facilitate distribution of water for a family showering together, the linear pipes 102 will be long enough so that enough water reaches each person. In an embodiment, the linear pipes 102p-105p are sized between about four inches and ten inches in length and between about ½″ to ¾″ in inner diameter width.

As illustrated, there are four (4) substantially identical linear pipes that are divided into a first set (102p, 104p) and a second set (103p, 105p), respectively, each set arranged inline, wherein the first set and the second set intersect forming an “X” configuration.

In an embodiment, the linear pipes 102p-105p can be connected to the corresponding outlet ports 102o-105o by threading. In other embodiments, another fastening means such as friction fitting or an adhesive can be used. In an embodiment, the distal ends of the outlet pipes 102p-105p can be connected to the elbow pipes 106 by threading. In other embodiments, another fastening means such as friction fitting or an adhesive can be used.

As illustrated, the inlet port 105 is connected to an inlet pipe 107. The inlet pipe 107 is disposed vertically relative to the ground, and is connectable to a water source pipe in a shower system.

To install the water distribution device for family showering 100, the inlet pipe 107 is connected to the water source pipe. Accordingly, the water distribution device for family showering 100 is suspended (hangs) from the water source pipe near the shower room ceiling any without additional support. In other words, the water distribution device for family showering 100 would take the place of the existing showerhead. If a showerhead already is attached, the existing showerhead will need to be removed before attaching the water distribution device for family showering 100. The inlet pipe 107 is threaded onto a complementarily threaded pipe (not shown) connected to the water source pipe, and individual standard-sized showerheads (not shown) are threaded to each of the elbow pipes 106. If useful, plumber's putty or thread seal tape can be used to seal the connection, and washer(s) can be employed at various connection points to ensure a lasting water seal. In embodiments, the inlet pipe 107 and the elbow pipes 106 include standard-sized ½-inch NPT (National Pipe Thread) threading defined under ANSI/ASME standard B1.20.1. This allows the device to connect to standard showers and employ standard sized showerheads.

Notably, the elbow pipes 106 are not pointed directly down. Instead, the elbow pipes 106 (and the attached showerheads) are directed toward a side of the device 100 (e.g., offset by at least about twenty degrees with respect to the vertical inlet pipe 107). Once the water is turned on, the pressurized water from the water source fills the chamber 101 and flows through the linear pipes 102p-105p and exits through the distal ends. If individual showerheads are fitted to the elbow pipes 106, the water would be dispensed via the showerheads. Given the relatively long distance of the pipes 102p-105p, the water distribution device for family showering 100 can conveniently be used for several people showering together.

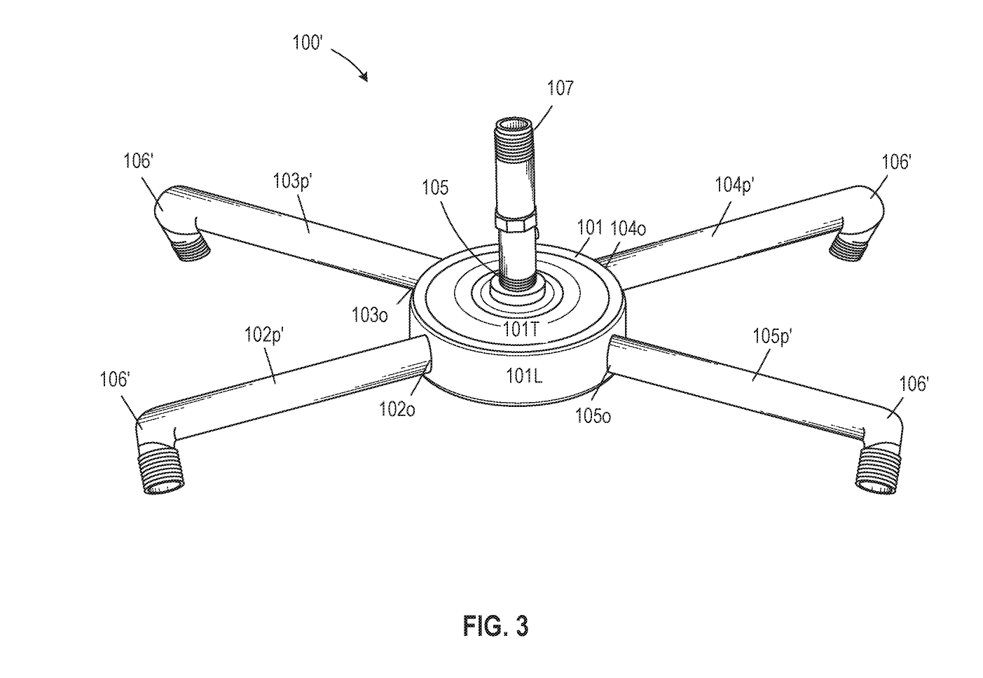

FIG. 3 shows another embodiment, designated with reference numeral 100′, wherein the linear pipes are made integral with each of the elbow pipes, respectively, instead of being individual piping. Thus, a first piece includes an integrally formed linear pipe 102p′ portion and elbow pipe 106, a second piece includes an integrally formed linear pipe 103p′ portion and elbow pipe 106, a third piece includes an integrally formed linear pipe 104p′ portion and elbow pipe 106, and a fourth piece includes an integrally formed linear pipe 105p′ portion and elbow pipe 106. The linear pipes 102p-105p could be secured to the ports 102o-105o (e.g., using an adhesive) or the entire device 101′ made from a single mold, for example. The sizes and lengths of the linear pipes 102a′-105′ and the elbow pipes 106 are the same. The water distribution device for family showering 100′ is in other respects identical with the water distribution device for family showering 100 described above including that the inlet pipe 107 and the elbow pipes 106′ have standard-sized ½-inch NPT threading.

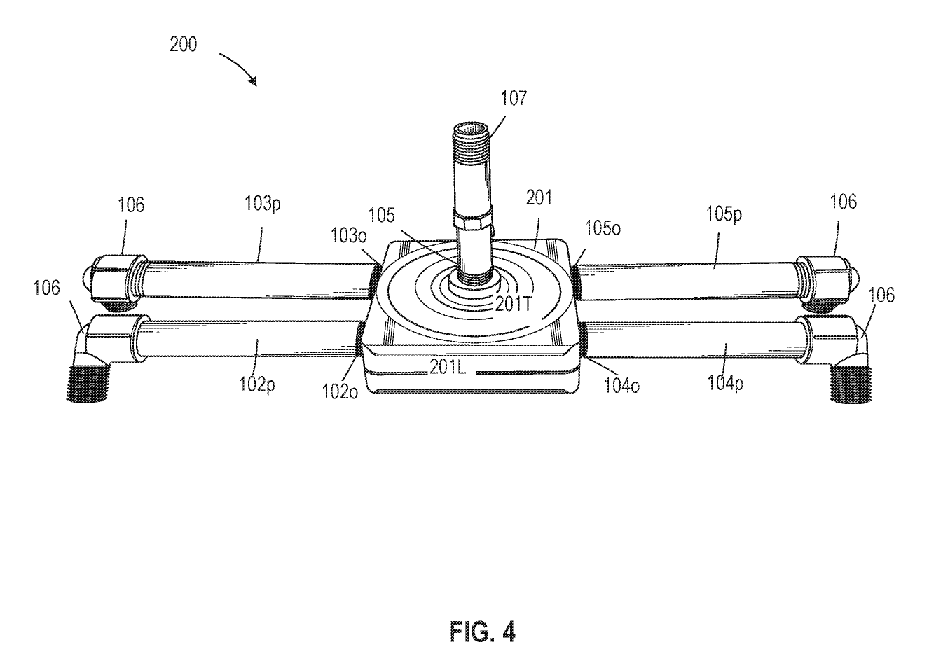

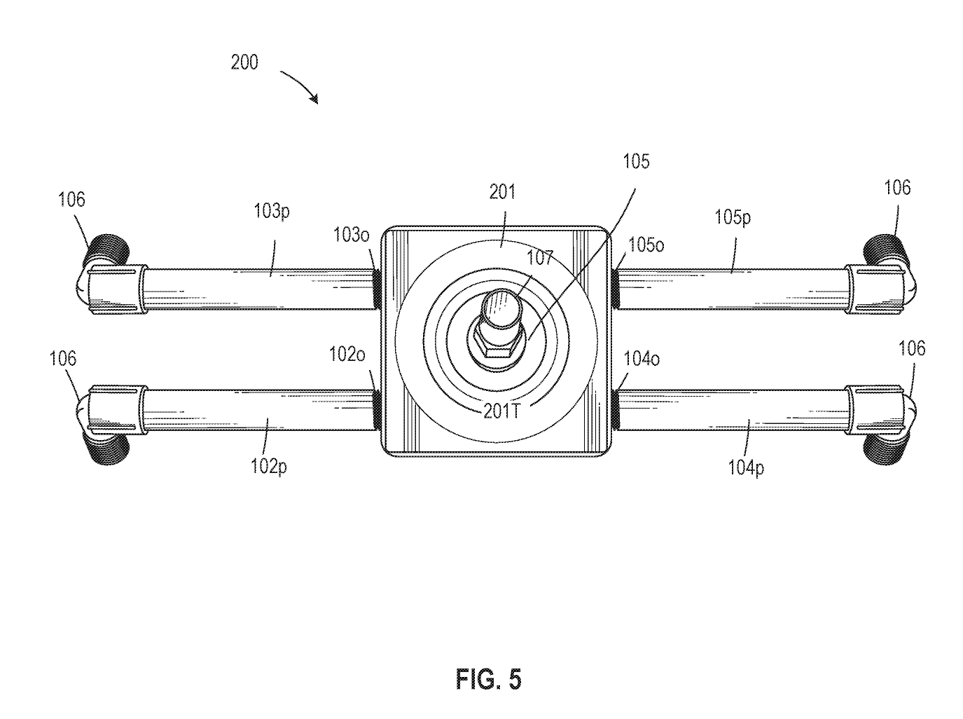

Referring to FIG. 4, a perspective view of a water distribution device for family showering 200, according to another embodiment of the present invention, is illustrated. FIG. 5 shows a top view of the water distribution device for family showering 200. The main difference between the water distribution device for family showering 100 and the water distribution device for family showering 200 is that the linear pipes 102p-105p are arranged differently. As shown, the first set (102p, 104p) and the second set (103p, 105p) are each arranged parallel to one another. Additionally, the chamber 201 has a square (cubic) shape compared to the cylindrical shape of chamber 101; however, the shape of the chamber in either case is a design choice that can be varied. The outlet ports 202o-205o are substantially the same as the outlet ports 102o-105o but are arranged at different locations on the lateral side 201L of the chamber 201. The inlet port 105 is disposed on the top side (201T) of the chamber 201 as before. As before, the inlet pipe 107 and the elbow pipes 106 include standard-sized ½-inch NPT threading.

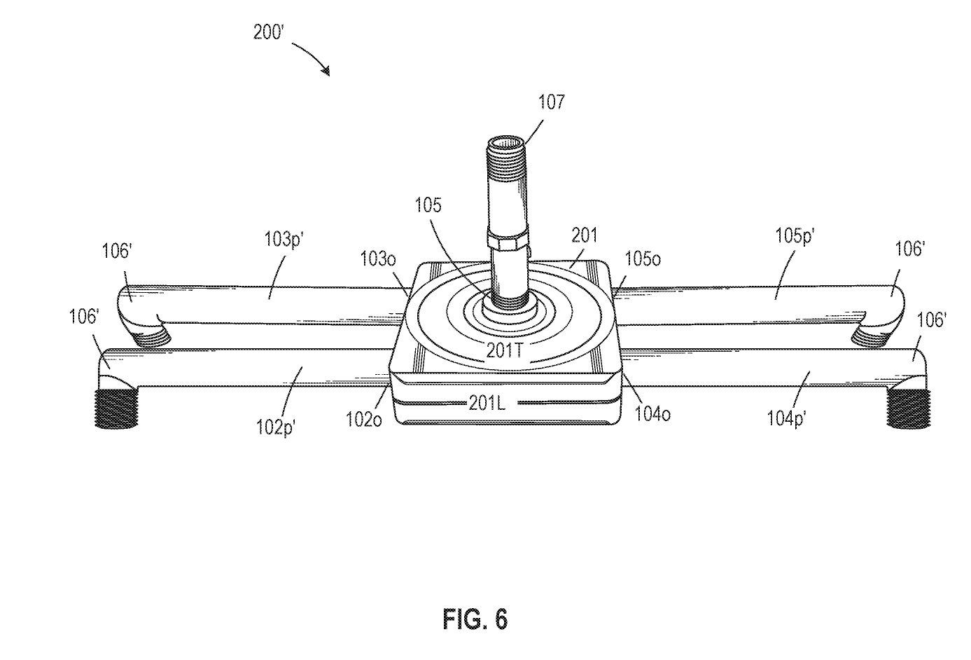

FIG. 6 shows another embodiment, designated with reference numeral 200′, wherein the linear pipes are made integral with each of the elbow pipes, respectively, instead of being individual piping. Thus, a first piece includes an integrally formed linear pipe 102p′ portion and elbow pipe 106, a second piece includes an integrally formed linear pipe 103p′ portion and elbow pipe 106, a third piece includes an integrally formed linear pipe 104p′ portion and elbow pipe 106, and a fourth piece includes an integrally formed linear pipe 105p′ portion and elbow pipe 106. The linear pipes 102p-105p could be secured to the chamber 201 (e.g., using an adhesive) or the entire device made from a single mold, for example. The sizes and lengths of the linear pipes 102a′-105′ and the elbow pipes 106 are the same. The water distribution device for family showering 200′ is in other respects identical with the water distribution device for family showering 100 described above including that the inlet pipe 107 and the elbow pipes 106′ have standard-sized ½-inch NPT threading.

In each of the embodiments, the device is constructed of lightweight materials such as plastic (e.g., PVC, ABS). This allows the device to be threaded to, and suspended from, an existing showerhead in a shower without additional support. In embodiments, the device is less than about three pounds, preferably less than one pound, in weight allowing it to be suspended from a shower source pipe without undue strain.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A water distribution device for family-showering, comprising:
a chamber including an inlet port and a plurality of outlet ports;
an inlet pipe attached to the inlet port capable of connection to a water supply pipe whence the water distribution device is suspended from the water supply pipe without additional support;
a plurality of linear pipes, each one of the linear pipes connected to a respective one of the outlet ports;
wherein distal ends of each of the linear pipes are structured to permit a respective shower head to be attached.

2. The water distribution device of claim 1, wherein the linear pipes comprise a first set of linear pipes and a second set of linear pipes, the first set and the second set intersect.

3. The water distribution device of claim 2, wherein the intersecting first set and the second set form an “X” configuration.

4. The water distribution device of claim 1, wherein the linear pipes comprise a first set of linear pipes and a second set of linear pipes, the first set and the second set are parallel.

5. The water distribution device of claim 1, wherein each of the linear pipes is at least about four inches in length.

6. The water distribution device of claim 1, wherein each of the linear pipes is between about four inches and twelve inches in length.

7. The water distribution device of claim 1, wherein elbow pipes are connected to each of the distal ends of the linear pipes.

8. The water distribution device of claim 7, wherein the elbow pipes are threaded to the linear pipes.

9. The water distribution device of claim 7, wherein each of the elbow pipes is integral with each a respective one of the linear pipes.

10. The water distribution device of claim 7, wherein the elbow pipes include threading useable for connecting showerheads thereto.

11. The water distribution device of claim 1, further including an inlet pipe attached to the inlet port.

12. The water distribution device of claim 11, wherein the elbow pipes are positioned with at least a about a twenty degree angle with respect to the inlet pipe.

13. The water distribution device of claim 1, wherein the linear pipes are substantially identical.

14. The water distribution device of claim 1, wherein each of the linear pipes are about ½ inch in inner diameter width.

15. The water distribution device of claim 1, wherein the distal ends include ½ inch NPT threading.
